(19) United States
(12) Patent Application Publication
(10) Pub. No.: US 2011/0017901 A1
(43) Pub. Date: Jan. 27, 2011

(54) Cane holder

(76) Inventors: Ronnie F. Denburg, Verona, NJ (US); Ina Denburg, Verona, NJ (US)

Correspondence Address: LITMAN LAW OFFICES, LTD., PATENT LAW BUILDING, 8955 CENTER STREET, MANASSAS, VA, 20110, US

(21) Appl. No.: 12/801,919

(22) Filed: Jul. 1, 2010

Related U.S. Application Data
(60) Provisional application No. 61/271,568, filed on Jul. 23, 2009.

(51) Int. Cl. F16M 13/00

(52) U.S. Cl. 248/689; 248/682

(57) ABSTRACT

The cane holder is a support device for the upper end of a conventional cane. The cane holder includes a main body having upper and lower surfaces, a front edge and a rear edge, and a pair of opposed side edges. An opening is formed through a central portion of the main body for receiving a portion of the cane. A slot extends between the front edge of the main body and the opening so that the portion of the cane may be inserted and removed from the opening via the slot. Preferably, at least the lower surface of the main body is substantially flat, allowing the lower surface to rest on a to flat surface, such as a tabletop, to support the cane. The rear edge of the main body may be substantially flat for resting against a wall, or may be concave for receiving the leg of a chair.

### CROSS-REFERENCE TO RELATED APPLICATION

This application claims the benefit of U.S. Provisional Patent Application Ser. No. 61/271,568, filed Jul. 23, 2009.

### BACKGROUND OF THE INVENTION

1. Field of the Invention

The present invention relates to supports, and particularly to a cane holder that supports the upper end of a cane, pole, walking stick, crutch, staff or other walking aid when not in use.

2. Description of the Related Art

Canes, walking sticks, crutches and the like are often used for movement and support by the elderly or infirm. Canes, in particular, typically include a cylindrical support pole and a handhold structure. The size and the shape of the handhold structure are typically fairly conventional, although the length of the support pole varies, depending on the distance between the user's hand and foot. The support's diameter is typically constant for most types of canes.

Although required for mobility, canes become unnecessary when the individual is, for example, seated or reclined. Thus, the cane must be stored by the user. During non-use, canes may be stored by placing them against a wall or other surface within proximity of the user. Canes placed in such positions, however, often slide on the wall surface, causing them to fall to the ground, which may make it difficult for the user to retrieve the cane without assistance. Additionally, users of canes and the like often lean their canes and other walking aids against tables and chairs where they pose a hazard to passerby.

Many attempts have been made to secure cylindrical objects, such as canes, to tabletops or other planar surfaces. However, for the most part, these holders require extensive manipulation by the user to connect and disconnect the cane, tabletop, and the cane holder itself.

Thus, a cane holder solving the aforementioned problems is desired.

### SUMMARY OF THE INVENTION

The cane holder is a support device for the upper end of a conventional cane. The cane holder allows the cane, or any other suitable type of walking aid, to be supported in a substantially vertical orientation when not in use, allowing for quick and easy retrieval by the user. The cane holder includes a main body having opposed upper and lower surfaces, a front edge, a rear edge, and a pair of opposed side edges. The main body is preferably formed from a resilient material, such as plastic or the like. An opening, is formed through a central portion of the main body and is adapted for receiving a portion of the cane. Preferably, the opening is substantially circular.

A slot extends between the front edge of the main body and the opening so that the cane may be inserted and removed from the opening via the slot. Preferably, at least the lower surface of the main body is substantially flat, allowing the lower surface to rest on a flat surface, such as a tabletop, to support the cane. The rear edge of the main body may be substantially flat, for resting against a wall, for example, or may be concave for receiving the leg of a chair.

In an alternative embodiment, the cane holder includes a mounting plate having opposed front and rear faces, and a support having opposed top and bottom surfaces and opposed front and rear edges. The rear edge of the support is secured to the front face of the mounting plate. Preferably, the rear face of the mounting plate is concave for receiving the cane. The rear face of the mounting plate may be secured to the cane by an adhesive, by bolts, or the like. The support may be fixed with respect to the mounting plate, or may be pivotally secured thereto.

These and other features of the present invention will become readily apparent upon further review of the following specification and drawings.

### BRIEF DESCRIPTION OF THE DRAWINGS

FIG. 1 is an environmental, perspective view of a cane holder according to the present invention, showing the cane being supported by a chair.

FIG. 2 is an environmental, perspective view of the cane holder according to the present invention, showing the cane being supported by a tabletop.

FIG. 3 is an environmental, perspective view of the cane holder according to the present invention, showing attachment of the cane holder to a cane.

FIG. 4 is a perspective view of the cane holder of FIG. 3.

FIG. 5 is a top view of the cane holder of FIG. 3.

FIG. 6 is an environmental, side view of the cane holder of FIG. 3, showing cane holder supporting the cane against a wall.

FIG. 7 is a perspective view of an alternative embodiment of a cane holder according to the present invention.

FIG. 8 is an environmental, perspective view of another alternative embodiment of a cane holder according to the present invention.

FIG. 9 is an environmental, perspective view of yet another alternative embodiment of a cane holder according to the present invention.

Similar reference characters denote corresponding features consistently throughout the attached drawings.

### DETAILED DESCRIPTION OF THE PREFERRED EMBODIMENTS

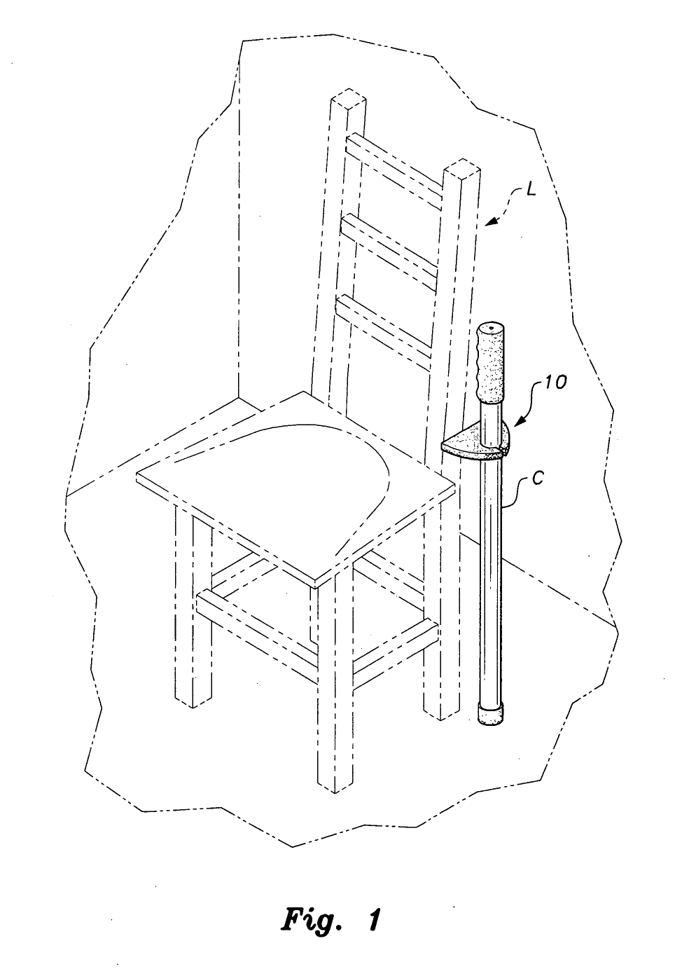

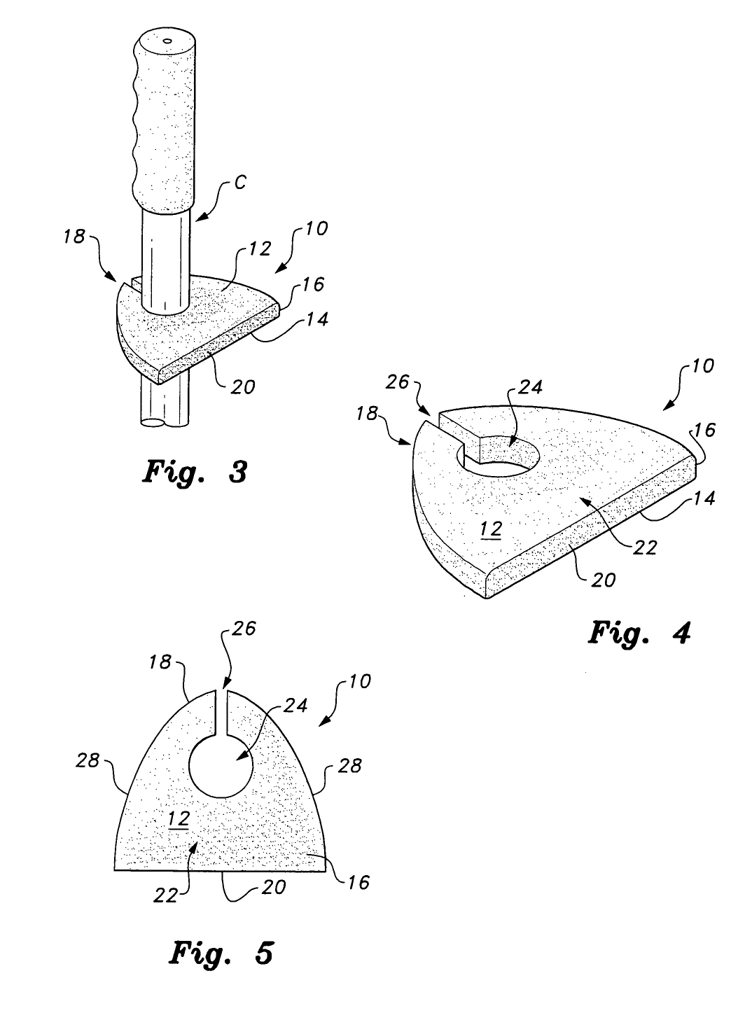

As shown in FIG. 1, the cane holder 10 is a device for supporting the upper end of a conventional cane C in an upright position when the cane C is leaned against a wall, chair, tabletop, or other conveniently available structure. As best shown in FIGS. 3, 4 and 5, the cane holder 10 includes a main body 16 having opposed upper and lower surfaces 12, 14, respectively, a front edge 18, and a rear edge 20. Preferably, the front edge 18 is substantially arcuate, as shown. The main body 16 further includes a pair of opposed side edges 28, which may also be substantially arcuate, as shown. The main body 16 is preferably formed from a resilient material, such as plastic or the like. It should be understood that any suitable type of resilient material may be utilized. Similarly, it should be understood that the overall shape and relative dimensions of main body 16 are shown for exemplary purposes only, and that the main body 16 may have other dimensions and configurations.

An opening 24 or bore is formed through a central portion 22 of the main body 16, as shown, and is adapted for receiving a portion of the cane C. Preferably, the opening 24 is substantially circular or cylindrical, and is dimensioned to snugly receive a conventional cane, with the cane body being held therein via frictional fit. It should be understood that the main body 16 and the opening 24 may be custom-sized and dimensioned for particular canes and similar walking sticks, crutches or the like.

A slot 26 extends between the front edge 18 of the main body 16 and the opening 24 so that the cane C may be inserted and removed from the opening 24 via the slot 26 in the manner of a clip. As shown, the main body 16 may be symmetric about a central axis extending from a vertex of the front edge 18 (with the front opening of slot 26 being defined at the vertex) to a center of the circular opening 24.

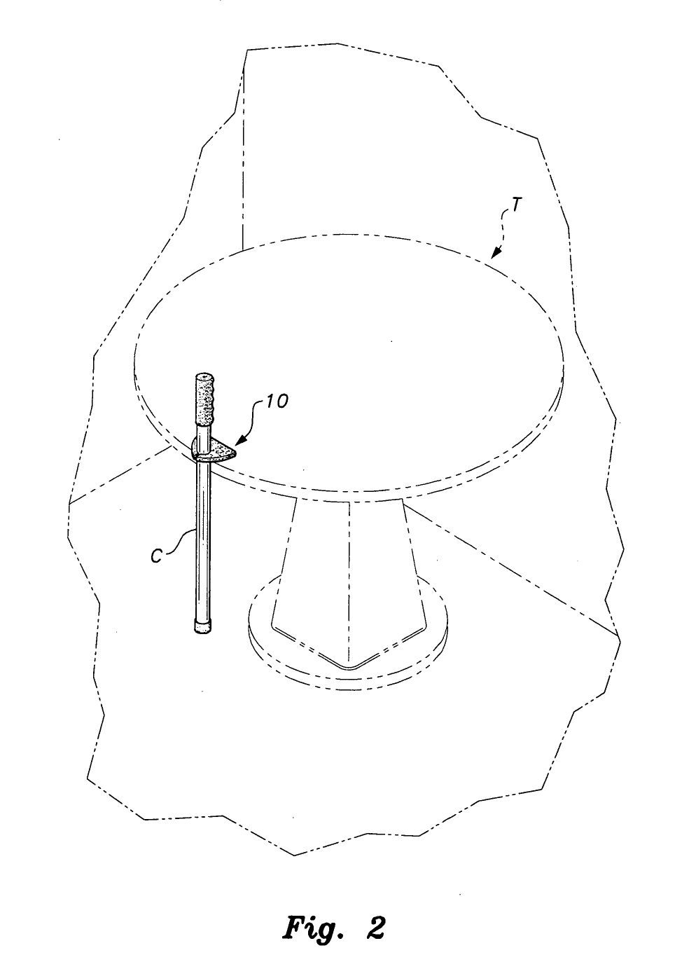

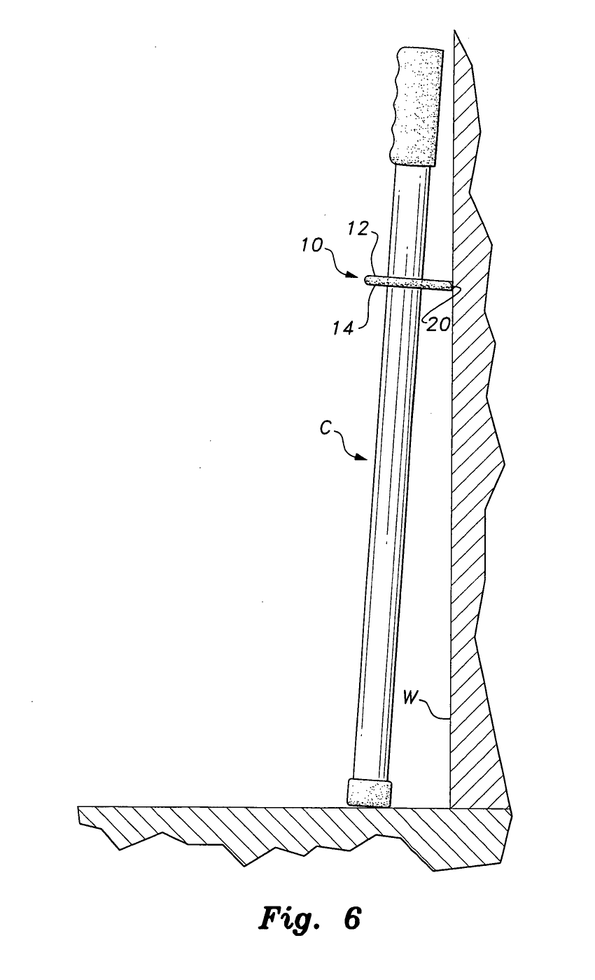

Preferably, at least the lower surface 14 of the main body 16 is substantially flat, allowing the lower surface 14 to rest on top of a horizontal flat surface, such as the exemplary tabletop T of FIG. 2, to support the cane C. The rear edge 20 of the main body 16 may also be substantially flat and elongated, as shown, for resting against a wall W, as shown in FIG. 6, or against a flat chair leg L, as in the example of FIG. 1.

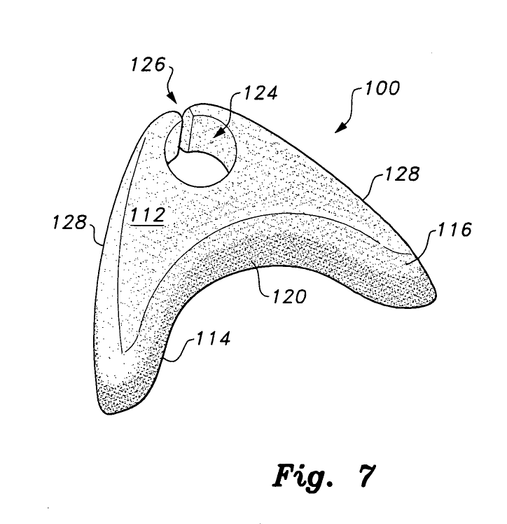

In the preferred alternative embodiment of FIG. 7, the cane holder 100 includes a main body 116 having opposed upper and lower surfaces 112, 114, respectively, and a front edge and a rear edge 120, similar to cane holder 10. Also similar to cane holder 10, the main body 116 further includes a pair of opposed side edges 128, along with a central circular opening 124 and a slot 126. As opposed to cane holder 10, the rear edge 120 is substantially arcuate, as shown. Preferably, rear edge 120 is concave, for receiving or bearing against a rounded chair leg or the like. In use, the cane holder 100 (as well as the cane holder 10 of the previous embodiment) is positioned on the cane C by squeezing the laterally opposed ends of rear edge 120 toward one another, thus widening slot 126 and the diameter of circular opening 124.

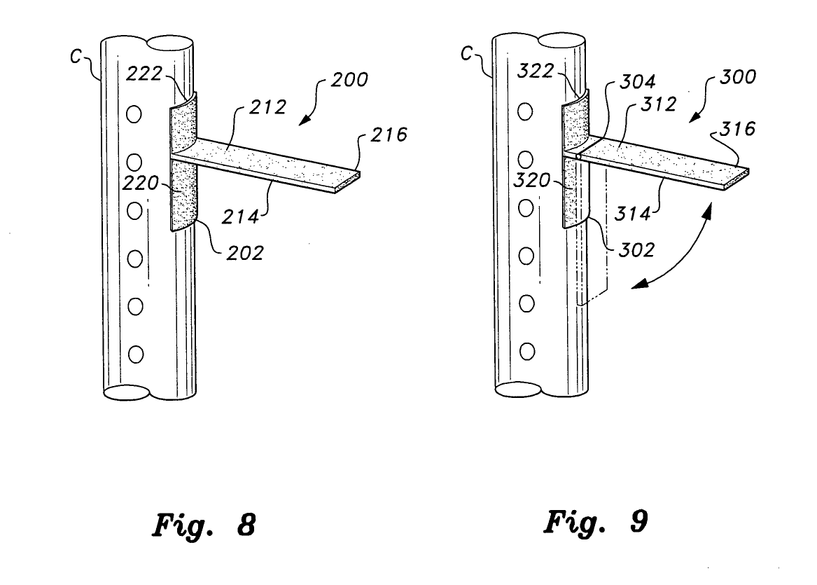

In a further alternative embodiment, the cane holder 200 of FIG. 8 includes a mounting plate 202 having opposed front and rear faces 220, 222, respectively, and a support 216 having opposed top and bottom surfaces 212, 214, and further having opposed front and rear edges. The rear edge of the support 216 is attached to the front face 220 of the mounting plate 202, and the support 216 normal to the front face 220 of the mounting plate 202. The support 226 may be approximately two inches long, although it should be understood that the overall dimensions and configuration of the support 216 are shown for exemplary purposes only.

Preferably, the rear face 222 of the mounting plate 202 is concave for receiving the cane C, and the rear face 222 may be attached to the cane by adhesive, by bolts, or the like. As shown, the front edge of support 216 may be flat, similar to the rear edge of cane holder 10 of FIGS. 1 and 6, in order to rest against a flat support surface. The lower surface 214 is also preferably flat for supporting the cane C on a horizontal flat surface, similar to that of cane holder 10 of FIG. 2. Support 216 and mounting plate 202 may be formed integrally as a one-piece molded body.

In the alternative embodiment of FIG. 9, the cane holder 300 similarly includes a mounting plate 302 having opposed front and rear faces 320, 322, respectively, and a support 316 having opposed top and bottom surfaces 312, 314 and opposed front and rear edges. The rear edge of the support 316 is attached to the front face 320 of the mounting plate 302. As opposed to cane holder 200, in which the support 216 is rigidly fixed in place with respect to mounting plate 202, the support 316 is pivotally attached to the mounting plate 302 via a hinge 304 or the like. Thus, the support 316 may be folded against the front face 320 of mounting plate 302 when not in use.

Similar to cane holder 200, the rear face 322 of the mounting plate 302 is preferably concave for receiving the cane C, and the rear face 322 is attached to the cane C by adhesive, by bolts, or the like. As shown, the front edge of support 316 may be flat, similar to the rear edge of cane holder 10 of FIGS. 1 and 6, in order to rest against a flat support surface. The lower surface 314 is also preferably flat for supporting cane C on top of a flat horizontal surface, similar to that of cane holder 10 of FIG. 2.

Although shown as being used in combination with an exemplary cane C, it should be understood that the cane holder of the above embodiments may be applied to any walking aid, such as, for example, poles, walking sticks, crutches, staffs or the like. Alternatively, the cane holder may be used with any other suitable device having a substantially circular or cylindrical handle or body, such as brooms, mops, umbrellas, hoses, plungers, dust trays or the like. It should be understood that the cane support may be manufactured in a variety of sizes, allowing a similar support to be used with devices having smaller (or larger) diameter handles, such as dusting wands, hiking sticks and the like. Additionally, although shown in the exemplary Figures as being used to support an exemplary walking aid against a wall, a chair leg, on a table, etc., it should be understood that the cane supports described above may be used to support a cane or other device against any desired support surface, such as a protruding corner of a doorway, for example, or to wedge the cane or other device underneath a table or the like.

It is to be understood that the present invention is not limited to the embodiments described above, but encompasses any and all embodiments within the scope of the following claims.

We claim:

1. A cane holder, comprising a main body having opposed upper and lower surfaces, a front edge and an elongated rear edge, the main body having an opening formed therethrough extending between the upper surface and the lower surface, the opening being adapted for retaining a portion of a cane, the main body having a slot extending between the front edge and the opening so that the portion of the cane is inserted and removed from the opening through the slot, the lower surface and the rear edge of the main body being adapted for bearing against support surfaces.

2. The cane holder as recited in claim 1, wherein the front edge is substantially arcuate.

3. The cane holder as recited in claim 2, wherein said main body has a pair of opposed side edges, each of the side edges being substantially arcuate.

4. The cane holder as recited in claim 3, wherein the opening is substantially circular.

5. The cane holder as recited in claim 4, wherein said main body is substantially symmetric about an axis extending from a vertex of the front edge to a center of the opening.

6. The cane holder as recited in claim 5, wherein the rear edge is substantially flat.

7. The cane holder as recited in claim 5, wherein the rear edge is substantially arcuate.

8. The cane holder as recited in claim 5, wherein the rear edge is concave.

9. A cane holder, comprising a main body having:
opposed upper and lower surfaces, a front edge and a concave rear edge;
a central bore extending through the main body from the upper surface to the lower surface, the bore being dimensioned and configured for retaining a portion of a cane therein; and
a slot extending between the front edge and the central bore, whereby the portion of the cane is inserted into and removed from the bore through the slot;
wherein the lower surface and the rear edge of the main body have flat surfaces adapted for bearing against support surfaces.

10. The cane holder as recited in claim 9, wherein the front edge is substantially arcuate.

11. The cane holder as recited in claim 10, wherein said main body has a pair of opposed side edges, each of the side edges being substantially arcuate.

12. The cane holder as recited in claim 11, wherein the central bore is substantially cylindrical.

13. The cane holder as recited in claim 12, wherein said main body is substantially symmetric about an axis extending from a vertex of the front edge to an axial center of the central bore.

14. The cane holder as recited in claim 13, wherein said main body is formed from a resilient material.

15. The cane holder as recited in claim 14, wherein said main body is formed from plastic.

16. A cane holder, comprising:
a mounting plate having opposed front and rear faces;
a support having opposed top and bottom surfaces and opposed front and rear edges, the rear edge of the support being attached to the front face of the mounting plate, the support extending substantially normal to the front face of the mounting plate when extended for use, the front edge and the bottom surface of the support being adapted for bearing against support surfaces; and
means for attaching the rear face of the mounting plate to a portion of a cane.

17. The cane holder as recited in claim 16, wherein the rear face of said mounting plate is arcuate.

18. The cane holder as recited in claim 17, wherein the rear face of said mounting plate is concave.

19. The cane holder as recited in claim 18, wherein said means for attaching comprises means for pivotally attaching said support to the front face of said mounting plate.

20. The cane holder as recited in claim 19, wherein said means for pivotally attaching said support to the front face of said mounting plate comprises a hinge.
